(19) United States
(12) Patent Application Publication
(10) Pub. No.: US 2013/0094208 A1
(43) Pub. Date: Apr. 18, 2013

(54) LED STREET LIGHT

(71) Applicants: Jason Jae Gill, Seocho-gu (KR); Sang Dong Jeong, Seo-gu (KR); Do Haeng Ryu, Uijeongbu-si (KR); Yun Na Lee, Ansan-si (KR); Jae Yeong Lee, Gangseo-gu (KR)

(72) Inventors: Jason Jae Gill, Seocho-gu (KR); Sang Dong Jeong, Seo-gu (KR); Do Haeng Ryu, Uijeongbu-si (KR); Yun Na Lee, Ansan-si (KR); Jae Yeong Lee, Gangseo-gu (KR)

(73) Assignee: AMOLUXE CO., LTD., Cheonan-si (KR)

(21) Appl. No.: 13/639,899

(22) PCT Filed: Mar. 31, 2011
(86) PCT No.: PCT/KR2011/002201

§ 371 Date: Dec. 27, 2012

(30) Foreign Application Priority Data
Apr. 9, 2010 (KR) 10-2010-0032555
Mar. 4, 2011 (KR) 10-2011-0019588

(51) Int. Cl. F21V 29/00; F21V 7/00

(52) U.S. Cl. CPC F21V 29/2206; F21V 7/00
USPC 362/235; 362/247; 362/249.02

(57) ABSTRACT

Provided is a light-emitting diode (LED) streetlight that can implement LED lighting having a high heat emission efficiency and a favorable light distribution function, while maintaining a prototype of general post top lights as they are at maximum. The LED streetlight includes: a connection member that is placed on top of a post; a transparent or translucent protective cover that is placed on top of the connection member; a least one LED module that is surrounded by the protective cover; and a heat sink that is placed on top of the protective cover, to thus form an accommodation space that accommodates the LED module together with the connection member, in which the LED module is placed on the bottom surface of the heat sink, to thus allow heat generated from the LED module to be radiated outwardly.

### TECHNICAL FIELD

The present invention relates to light-emitting diode (LED) streetlights, and more particularly, to post top type LED streetlights that can implement LED lighting having a high heat emission efficiency and a favorable light distribution function, while maintaining a prototype of general post top lights as they are at maximum.

### BACKGROUND ART

In general, post top lights are formed to have lights that are respectively installed in the upper portions (or top portions) of posts. In the case of the post top lights incandescent, a metal halide, HPS (high pressure sodium) lamp is mounted in the inside of a glass tube, and a glare ring or louver is separately installed in the outside of the glass tube. Otherwise, the glass tube is frosted or processed with a translucent material to hide a light source such as lamp, to thereby achieve an anti-glare effect.

Lighting efficiencies of incandescent lamps, metal halide lamps, etc., that are employed as light sources in such conventional post top fights, are lower than those of LED lamps, and thus LED streetlights adopting post top type lights are nowadays being developed in which existing light sources are replaced with LED light sources.

In this case, heat generated from LED lamps is accumulated toward the inside of a polygonal printed circuit board (PCB) on which LEDs are mounted. As a result, it is difficult to discharge the heat toward the upper portion of the polygonal PCB. In other words, LED lights may solve to problem of a light distribution to illuminate a large area, but may cause a failure of LEDs or a loss of a lighting efficiency due to the heat emission problem.

Meanwhile, in order to improve the heat emission problem, LEDs are mounted at the head portions of post top lights to thus have a little advantageous heat dissipation effect. However, in this case, since light from the LED lamps is directed only downward, it is not only unfavorable to implement a desired light distribution structure, but also problematic to cause a light efficiency to fall. These problems may be solved through light distribution by using asymmetric lenses, but even in this case, since a lot of light is also emitted downward to this make it difficult to expect an increase in a light efficiency.

### DISCLOSURE

### Technical Problem

Accordingly, to solve the above conventional problems or defects, it is an object of the present invention to provide post top type light-emitting diode (LED) streetlights that can implement LED lighting having a high heat emission efficiency and a favorable light distribution function, by using a heat sink that is extended outwardly from an inner portion where LEDs are mounted, while maintaining a prototype of general post top lights as they are at maximum.

It is another object of the present invention to provide LED streetlights having an assembly structure that power drives and alternating-current (AC) to direct-current (DC) converters are easily maintained and repaired.

It is still another object of the present invention to provide LED streetlights that increase transmittance of light to thus implement a high-efficiency light distribution curve, by using a bowl-shaped protective cover, in which an angle of an appearance of the protective cover is arbitrarily set depending on an angle at which LEDs are mounted.

It is yet another object of the present invention to provided LED streetlights that can implement emotional illumination to thereby produce a variety of designs of the LED streetlights.

### Technical Solution

To accomplish the above and other objects of the present invention, there is provided a light-emitting diode (LED) streetlight comprising:

a connection member that is placed on top of a post;

a transparent or translucent protective cover that is placed on top of the connection member;

at least one LED module that is surrounded by the protective cover; and

a heat sink that is placed on top of the protective cover, to thus form an accommodation space that accommodates the LED module together with the connection member, in which the LED module is placed on the bottom surface of the heat sink, to this allow heat generated from the LED module to be radiated outwardly.

Preferably but not necessarily, the LED streetlight further comprises a top cover that is detachably coupled on the upper side of the heat sink, to thus form an accommodation space between the heat sink and the top cover, in which the accommodation space accommodates a power supply for the LED module.

Preferably but not necessarily, the heat sink is detachably supported to a number of support rods that are vertically connected to the connection member through connection bolts, and the top cover is installed on the heat sink by fixing bolts fastened with the connection bolts.

Preferably but not necessarily, the LED streetlight further comprises a reflector that is disposed between the heat sink and the top cover, or between the protective cover and the heat sink, and has a diameter larger than that of the heat sink.

Preferably but not necessarily, the LED streetlight further comprises a glare-blocking member that surrounds part of the outer circumference of the protective cover, in which the glare-blocking member is position-set at a height that corresponds to a location where the LED module is installed.

Preferably but not necessarily, the LED module comprises: a plurality of blocks that are fixed on the bottom surface of the heat sink,

wherein each block comprises: at least one LED package; and

an inclined surfaces on which the at least one LED package is placed, and

wherein each inclined surface of each block has a pre-set tilt angle so as to implement a desired light distribution curve through the LED module, and is fixed on the bottom surface of the heat sink in a direction corresponding to the light distribution curve.

Preferably but not necessarily, the LED module comprises:

a number of LED packages; and

a polygonal block on the faces of which have inclined surfaces en which the LED packages are placed and that is fixed on the bottom surface of the heat sink.

Preferably but not necessarily, the LED streetlight further comprises a glare-blocking member that surrounds the upper-outer circumference of the protective cover, in which the lower end of the glare-blocking member is set in correspondence to a location where both a tilt angle and a cutoff angle of the LED module with respect to the LED package match.

Preferably but not necessarily, the heat sink comprises:

a flat base plate on the bottom surface of which the at least one LED module is installed; and

a plurality of radiation fins protruding radially on the top and bottom surfaces of the base plate.

Preferably but not necessarily, the radiation fins comprises outer radiation fins that are arranged on the top and bottom surfaces of the outer portion of the base plate. In this case, the radiation fins comprises inner radiation fins that are arranged on the top surface of the inner portion of the base plate.

Preferably but not necessarily, the LED streetlight further comprises at least one auxiliary LED that is installed on the top surface of the base plate, wherein a number of light passage holes are formed on the top cover, to thus implement emotional illumination through the auxiliary LED.

Preferably but not necessarily, the LED streetlight further comprises at least one auxiliary LED that is installed on the top surface of the base plate, wherein the top cover is made of a transparent or translucent synthetic resin.

Preferably but not necessarily, the protective cover is formed in a bowl shape so that light emitted from the LED package is perpendicularly incident.

Preferably but not necessarily, the LED streetlight further comprises a number of support rods both ends of which are connected between the connection member and the heat sink outwardly from the protective cover, to thus fix the protective cover that is disposed between the connection member and the heat sink.

According to another aspect of the present invention, there is provided a light-emitting diode (LED) streetlight comprising:

a connection member that is placed on top of a post;

a transparent or translucent protective cover that is placed on top of the connection member;

a heat sink that is placed on top of the protective cover, and that is fixed by a number of support rods extending outwardly to the protective cover from the connection member, to thus allow heat to be radiated outwardly;

at least one LED module that is placed on the bottom surface of the heat sink and surrounded by the protective cover; and

a top cover that is detachably coupled on the upper side of the heat sink, to thus form an accommodation space between the heat sink and the top cover,

wherein the heat sink comprises radiation fins that are formed on the outer circumference extended from the protective cover so as to radiate heat generated from the module outwardly.

Preferably but not necessarily, the LED streetlight further comprises a reflector that is disposed between the heat sink and the top cover, and has a diameter larger than that of the heat sink.

Preferably but not necessarily, the LED streetlight further comprises a glare-blocking member that surrounds the outer circumference of the upper portion of the protective cover.

Preferably but not necessarily, the LED streetlight further comprises at least one auxiliary that is installed on the top surface of the heat sink, wherein the top cover is made of a transparent or translucent synthetic resin.

Preferably but not necessarily, the heat sink is detachably supported to a number of support rods that are connected to the connection member through connection bolts, and the to cover is detachably installed on the heat sink by fixing bolts fastened with the connection bolts.

Preferably but not necessarily, the LED streetlight further comprises:

a reflector that is provided on the upper portion of the connection member and that reflects light emitted downward from the LED modulo; and

a conduit that is extended from the upper end of the reflector to the heat sink and through which a power cable passes.

### Advantageous Effects

As described above, a post top type light-emitting diode (LED) streetlight according to the present invention, provides advantages of effectively radiating heat generated from a number of LED modules and implementing a favorable light distribution function through the LED modules that are arranged on the bottom surface of the heat sink in various arrays, while maintaining a prototype of general post top lights as they are at maximum.

In addition, the present invention provides a light-emitting diode (LED) streetlight having an assembly structure that a power drive and an alternating-current (AC) to direct-current (DC) converter are disposed in the inner side of the top cover, to thus easily maintain and repair the power drive and the AC to DC converter.

In addition, the present invention provides a light-emitting diode (LED) streetlight that increases transmittance of light to thus implement a high-efficiency light distribution curve, by using a bowl-shaped protective cover, in which an angle of an appearance of the protective cover is arbitrarily set depending on an angle at which a number of LEDs are mounted, and that makes it easy to design a light distribution curve by using the LEDs that are mounted in various angles.

Furthermore, a light-emitting diode (LED) streetlight according to the present invention comprises a number of auxiliary LEDs that are disposed on the upper side of a heat sink and a top cover in which a number of light passage holes are formed or that is made of an acryl resin that is transparent or has a variety of colors, to thereby implement illumination performance in various forms through emotional illumination in addition to direct illumination.

### DESCRIPTION OF DRAWINGS

FIG. 1 is a perspective view showing an assembled light-emitting diode (LED) streetlight according to a first embodiment of the present invention.

FIG. 2 is an exploded perspective view showing the LED streetlight according to the first embodiment of the present invention.

FIG. 3 is a side view showing the LED streetlight according to the first embodiment of the present invention.

FIG. 4 is a cross-sectional view taken along a line IV-IV shown in FIG. 3.

FIG. 5 a cross-sectional view taken along line V-V shown in FIG. 3.

FIG. 6 is a perspective view showing a light-emitting diode (LED) module installed on the bottom surface of a heat radiation member.

FIGS. 7A and 7B are a side view and a perspective view showing a light-emitting diode (LED) streetlight according to a second embodiment of the present invention, respectively.

FIGS. 8A and 8B are a side view and a perspective view showing a light-emitting diode (LED) streetlight according to a third embodiment of the present invention, respectively.

FIG. 8C is a perspective view showing an example that a number of small light passage holes are formed in a glare-blocking member.

FIGS. 9A and 9B are a side view and a perspective view showing a light-emitting diode (LED) streetlight according to a fourth embodiment of the present invention, respectively.

FIG. 10A is a side view showing a light-emitting diode (LED) streetlight according to a fifth embodiment of the present invention.

FIG. 10B is a longitudinal cross-sectional view showing, the light-emitting diode (LED) streetlight according to the fifth embodiment of the present invention.

FIG. 11A is a perspective view showing a light-emitting diode (LED) streetlight according to a sixth embodiment of the present invention.

FIG. 11B is a perspective view showing the light-emitting diode (LED) streetlight of FIG. 11A from which a reflector is removed to show a heat sink.

FIG. 11C is a cross-sectional view taken along a line V-V shown in FIG. 11A.

FIG. 11D is a schematic diagram showing a light distribution curve indicated by LED modules that are arranged as shown in FIG. 11C.

FIG. 11E is a schematic diagram showing a different arrangement of LED modules.

FIG. 11F is a schematic diagram showing a light distribution curve indicated by the LED modules that are arranged as shown in FIG. 11E.

### BEST MODE

Hereinbelow, light-emitting diode (LED) streetlights according to preferred embodiments of the present invention will be described in detail with reference to the accompanying drawings.

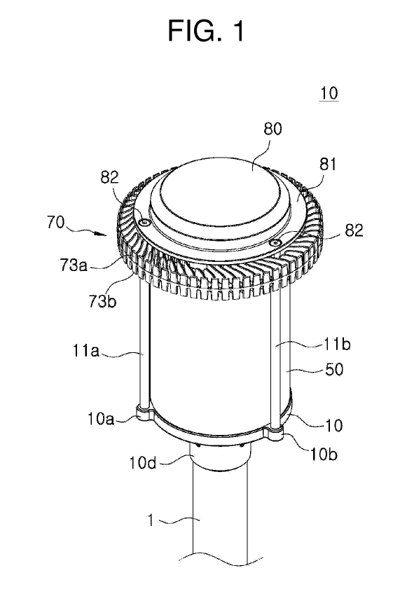

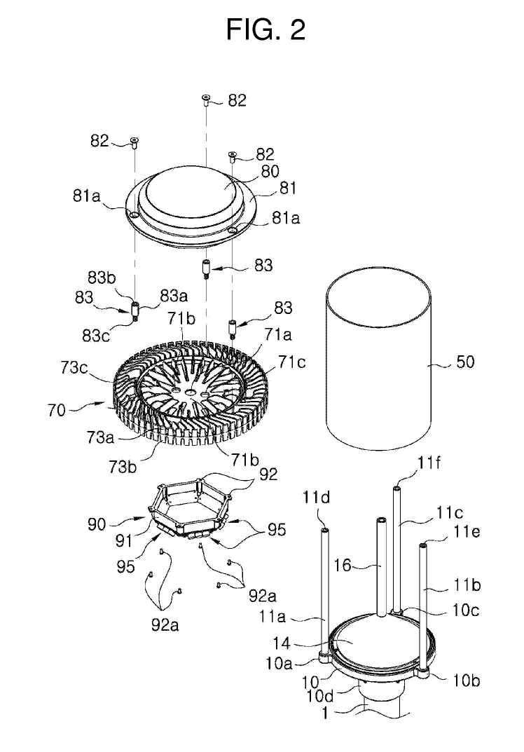

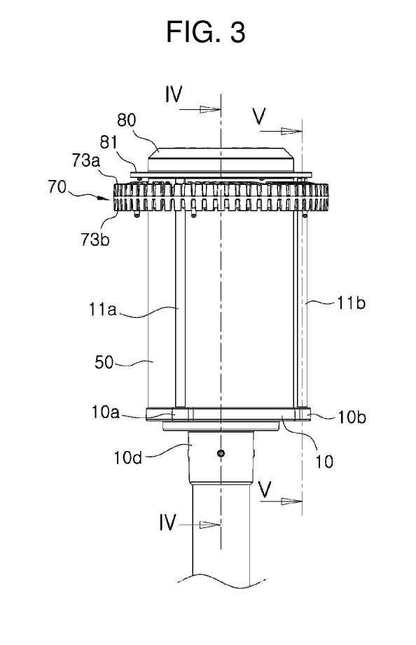

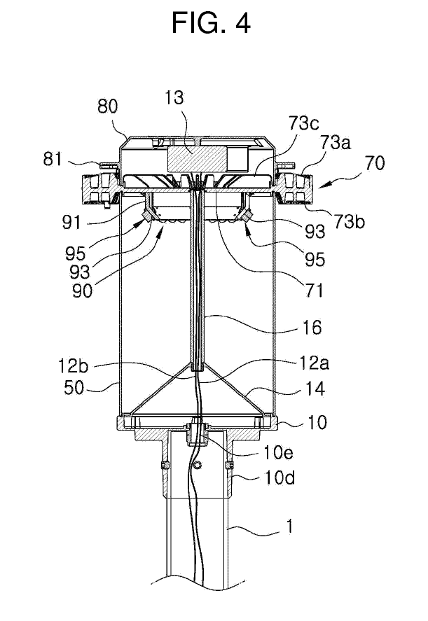

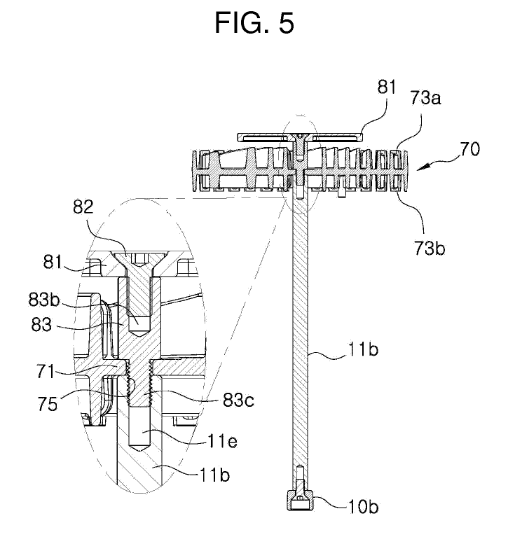

First, a configuration of a post top LED streetlight 100 according to a first embodiment of the present invention will be described in detail with reference to FIGS. 1 to 6. The LED streetlight 100 includes: a connection member 10; a protective cover 50; a heat sink 70; a top cover 80; and a LED module 90.

The connection member 10 is formed to include fixing portions 10a, 10b, and 10c that are protruded along the outer periphery of the connection member 10 and through which lower ends of a number of support rods 11a, 11b, and 11c are respectively inserted and fixed. An inserting portion 10d through which an upper end of a post 1 is inserted and fixed is protrudingly formed below the connection member 10. In addition, a passage hole 10e through which power cables 12a and 12b pass is formed in the inside of the connection member 10 in which the power cables 12a and 12h are disposed along the post 1.

The support rods 11a, 11b, and 11c support the heat sink 70 together. In this embodiment, three support rods 11a, 11b, and 11c are shown, but are not limited thereto. Two or more support rods may be formed so as not to prevent light distribution depending on an installation purpose and environment of the LED streetlight 100.

Further, the support rods 11a, 11b, and 11c are preferably position-set at point in places beyond direct illumination positions, in order to avoid light generated from LED packages 95 of the LED module 90 from prod-acing shadows by interference of the support rods 11a, 11b, and 11c.

In addition, a substantially conically shaped reflector 14 is installed at the upper portion of the connection member 10. The reflector 14 reflects light emitted downward from the LED module 90 toward a road or sidewalk.

A conduit 16 is disposed between the upper vertex of the reflector 14 and the heat sink 70. The conduit 16 plays a role of guiding the power cables 12a and 12b that are aligned along the inside of the post 1 to an alternating-current (AC) to direct-current (DC) converter 13 that is disposed in the inside of the top cover 80. In this case, the conduit 16 may have various colors to thereby implement a variety of designs of the post top streetlights, by considering that the conduit 16 can be visually recognized from outside through the protective cover 50.

The protective cover 50 is disposed between the connection member 10 and the heat sink 70, in order to protect the LED module 90. The protective cover 50 is made of a transparent or translucent glass or a transparent synthetic resin in order that light emitted from the LED module 90 may be transmitted. In this case, the transparent synthetic resin may be a high strength acrylic resin (PMMA) or polycarbonate (PC).

The protective cover 50 is formed of a vessel shape, in which the cross-section of the protective cover 50 may be, for example, any one of a circular shape, an oval shape, and polygonal shapes such as triangle and rectangle. In the remaining embodiments except for a fifth embodiment of the present invention, the protective cover 50 has been described as a cylindrical shape. The protective cover 50 that is applied in the fifth embodiment of the present invention is formed of a bowl shape in order to prevent light emitted from the LED module 90 from being reflected and to maximize transmittance.

The heat sink includes: a base plate 71 on the bottom surface of which the LED module 90 is coupled and fixed with pieces; and a number of outer radiation fins 73a and 73b that are mutually symmetrically disposed on the outer sides of the top and bottom surfaces of the base plate 71. Here, the base plate 71 and the outer radiation fins 73a and 73b are integrally formed, but they may be separated from each other.

The bottom surface 71c of the base plate 71 is formed flatly, in order to facilitate installation of the LED module 90. In this case, since bulky components such as the LED module 90 are not disposed at the central portion of the top surface 71d of the base plate 71, the top surface 71d of the base plate 71 may secure a relative free area in comparison with the bottom surface of the base plate 71. Thus, a number of inner radiation fins 73c are formed at the central portion of the top surface of the base plate 71, to thus enlarge a heat radiation area and to accordingly improve a heat radiation performance.

In addition, an insertion hole 71a through which the upper end of the conduit 16 is inserted is formed at the center of the base plate 71. A pair of cable passage holes 71b through which cables 12a and 12b (see FIG. 1) that are connected from a power drive (hot shown) to the LED module 90 that are provided in the inside of the top cover 80 are formed at both ends of the base plate 71.

The inner radiation in 73c may be arranged at predetermined intervals in a substantially radial direction, and the outer radiation fins 73a and 73b may be formed in an inclined state at a predetermined angle in a direction from the center of the base plate 71, considering a cooling efficiency of the radiation fins. It is possible to alter an interval and angle of an array of the radiation fins in various forms so as to maximize a heat radiation efficiency considering environmental factors for installation of LED streetlights, for example, airflow temperature, etc.

The top cover 80 is detachably mounted on the upper side of the heat sink 70 by a number of fixing bolts 82. In this case, the fixing bolts 82 are penetratively inserted into insertion holes 81a formed on a flange 81 that is protruded along the outer periphery of the top cover 80, respectively.

In addition, the fixing bolts 82 are coupled with connection bolts 83 that connect the heat sink 70 on the upper ends of the support rods 11a, 11b, and 11c, respectively. Accordingly, although the fixing bolts 82 are loosened to thus disconnect the top cover 80 from the heat sink 70, the heat sink 70 is maintained to be in a state where the heat sink 70 is fixed to the support rods 11a, 11b, and 11c by the connection bolts 83. Thus, when a power drive (not shown) or an alternating-current (AC) to direct-current (DC) converter 13 that are provided in the inside of the top cover 80 are maintained and repaired, only the top cover 80 may be separated from the heat sink 70, to then maintain and repair the power drive (not shown) or the AC to DC converter 13.

Meanwhile, an anti-rotation surface 83a that is in contact with the heat sink 70 is formed on part of the outer circumference of each connection bolt 83, so as not to rotate with the fixing bolt 82 when the connection bolt 83 is connected with an disconnected from the fixing bolt 82. Also, each connection bolt 83 has a screw groove 83b on the upper end thereof, in which the fixing bolt 82 is coupled into the screw groove 83b. Also, each connection bolt 83 has a thread portion 83c on the lower end thereof, in which the thread portion 83c is coupled into a coupling groove 11d, 11e, or 11f that is formed on the upper end of the support rods 11a, 11b, or 11c.

Also, as described above, the power drive (not shown) such as a constant current circuit or the alternating-current (AC) to direct-current (DC) converter 13 are provided in the inside of the top cover 80. The power drive (not shown) is electrically connected with the LED module 90 through predetermined power cables, and the AC to DC converter 13 is connected with the power cables 12a and 12b. In this case, the AC to DC converter 13 is preferably a Switching Mode Power Supply (SMPS). Depending on the necessity, the power drive and the AC to DC converter may be integrated into a single power supply.

The LED module 90 includes a block 91 having a number of inclined surfaces 93 and a number of LED packages 95 that are coupled with the respective inclined surfaces 93 of the block 91.

The block 91 is formed of a roughly hexagonal shape, in which the LED packages 95 are fixedly mounted on the six inclined surfaces 93, respectively. A number of extended ribs 92 are formed at substantially the same angle on the upper an of the block 91. Coupling bolts 92a are penetratively coupled with the extended ribs 92 to thus allow the block 91 to be fixed on the bottom surface of the heat sink 70. The LED package 95 includes at lease one LED and a metal PCB that withstands at a heat emission temperature of the LED and simultaneously absorbs heat from the LED.

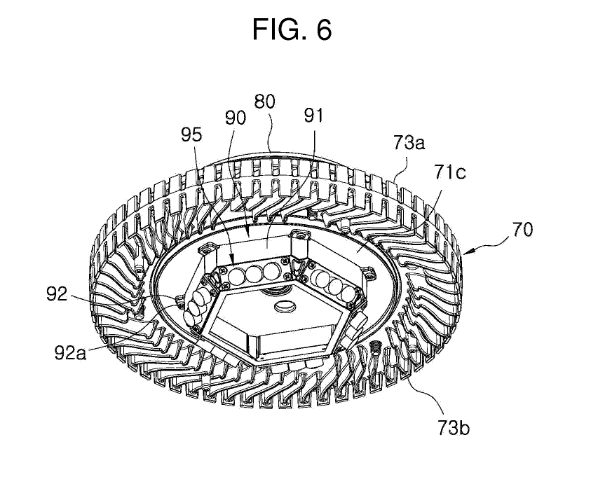

As shown in FIG. 6, the LET packages 95 are radially disposed. This arrangement is appropriate for light distribution for illuminating a large space such as parks and parking lots. However, in order to illuminate a long, narrow place such as sidewalks, bike lanes and car roads other than a large area such as parks and parking lots, the LED packages 95 may be disposed only at a place facing a road. In this case, it is desirable that an installation angle of the LED package 95 or an angle of the inclined surfaces 93 are properly formed to have a light distribution curve that is appropriate to illuminate the road.

As described above, the present invention may not only produce the proper light distribution that is suitable for the appropriate lighting conditions depending on a place, but may also focus illumination only where needed, to accordingly optimize a light distribution efficiency and maximize an optical efficiency.

In order to mount a number of the LED packages 95 on the heat sink 70, the LED module 90 according to the above-described embodiment has been described with respect to the case of using a hexagonal block 91 having six inclined surfaces 93, but the present invention is not limited thereto. For example, it is also possible to configure a number of unit blocks in which each unit block has a single inclined surface on which a signal LED package is mounted

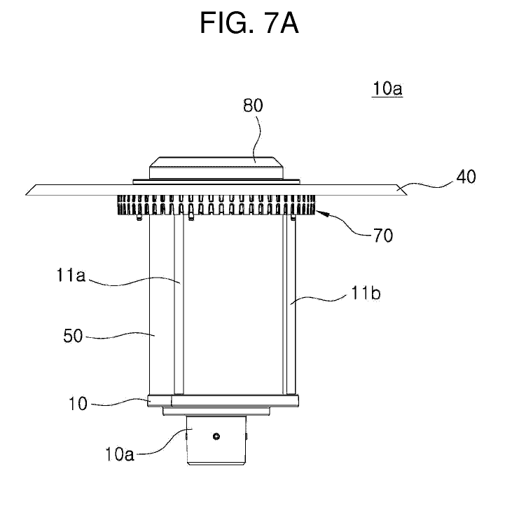

Referring to FIGS. 7A and 7B, a light-emitting diode (LED) streetlight according to a second embodiment of the present invention will be described below. The LED streetlight 100a in accordance with the second embodiment of the present invention further includes a reflector 40 in addition to the LED streetlight 100 according to the first embodiment.

The reflector 40 is fixedly installed between a heat sink 70 and a top cover 80, and plays a role of reflecting light directing upward from among light emitted from LED packages 95 toward downward, that is, a road or sidewalk, to thereby block light pollution and increase an optical efficiency.

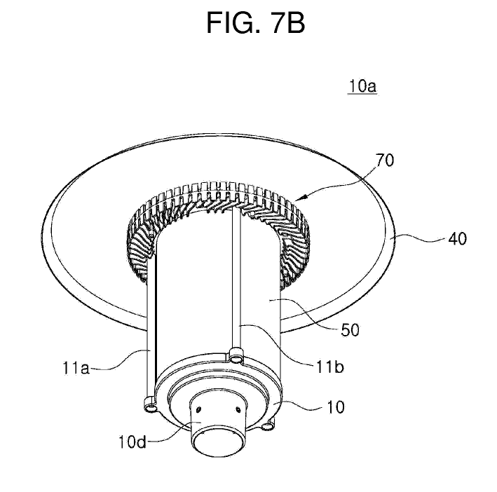

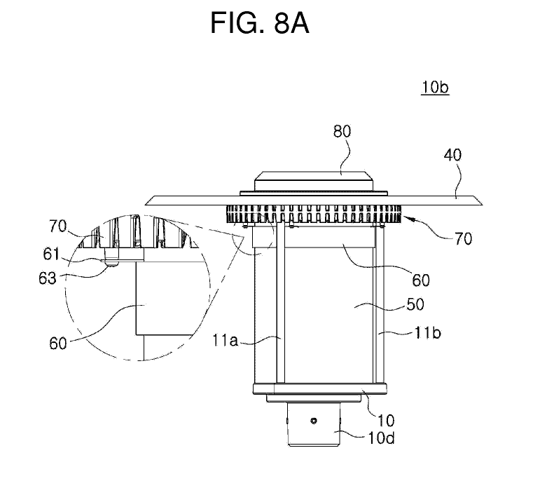

Referring to FIGS. 8A to 8C, a light-emitting diode (LED) streetlight according to a third embodiment of the present invention will be described below. The LED streetlight 100b in accordance with the third embodiment of the present invention further includes a glare-blocking member 60 in addition to the streetlight 100a according to the second embodiment.

The glare-blocking member 60 is roughly cylindrical, and is disposed along the outer circumference of a protective cover 50, to prevent glare from occurring due to light emitted from the TED packages 95 and directly irradiated to drivers and pedestrians. Here, the glare-blocking member 60 includes a number of extended ribs 61 with which pieces 63 are coupled, at the edges of the glare-blocking member 60, in order to secure the glare-blocking member 60 to the bottom of the heat sink 70 by means of the pieces 63.

In this case, the glare-blocking member 60 is configured to minimize limitation of an amount of light emitted from the LED packages 95 and maximize an anti-glare efficiency. For this purpose, it is desirable that the glare-blocking member (60 is set in a manner that a point in place where a tilt line and a cutoff line of the LED package 95 intersect coincides with the lower end of the glare-blocking member 60. The tilt angle of the LED package 95 represents a downward angle at which the LED package 95 is set toward the ground from the horizontal line, that is, an angle of inclination that is formed by the inclined surface 93 of the block 91, and the cutoff angle represents an angle of view.

Moreover, the glare-blocking member ftp is formed of an acrylic material with translucency or various colors, to thereby produce a feeling of softness and to improve a design.

In addition, referring to FIG. 8C, a glare-blocking member 60a may be, of course, formed to have a number of small light passage holes 63a. In this case, the light passage holes 63a are formed to have a smaller diameter gradually as it goes to the lower light passage holes from the upper light passage holes, in order to maintain an anti-glare effect. The light leaking through the light passage holes 63a may lead to more emotional illumination than direct illumination, in order to emphasize an aspect of a design of the LED streetlight 100b itself.

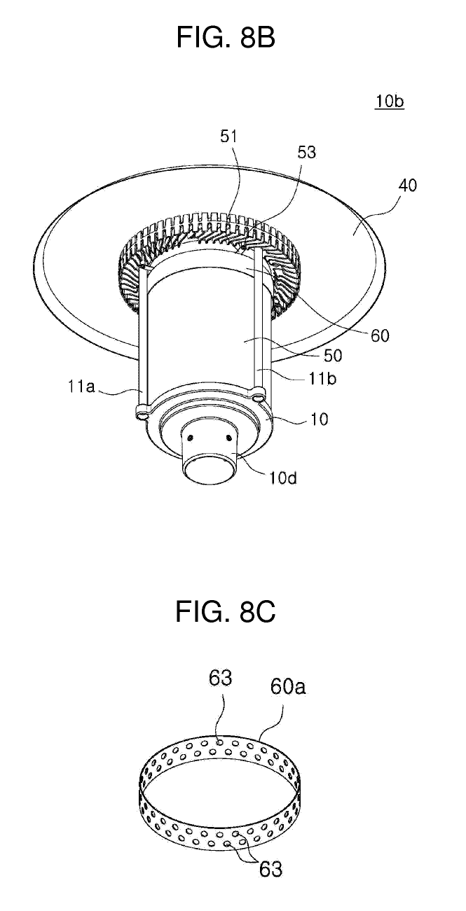

Referring to FIGS. 9A and 9B, a light-emitting diode (LED) streetlight according to a fourth embodiment of the present invention will be described below. The LED streetlight 100c in accordance with the fourth embodiment of the present invention is identical to that of the second embodiment of the present invention. Here, the former is different from the latter in a point that the reflector 40 is installed on the bottom of the heat sink 70.

In the case of the fourth embodiment, the reflector 40 plays a role of reflecting light directing upward from among light emitted from LED packages 95 toward downward, that is, a road or sidewalk, to thereby block light pollution and increase an optical efficiency.

Moreover, the heat sink 70 is not obstructed by the reflector 40 but is exposed to the rain and snow. Accordingly, the heat sink 70 may be cooled by the rain and snow, to thereby maximize a heat radiation effect.

The LED streetlight 100c according to the fourth embodiment, may further include a glare-blocking member 60 as in the LED streetlight 100b according to the third embodiment. In this case, it is desirable that the glare-blocking member 60 is disposed just under the reflector 40 and set to a location corresponding to a height of the LED module 90.

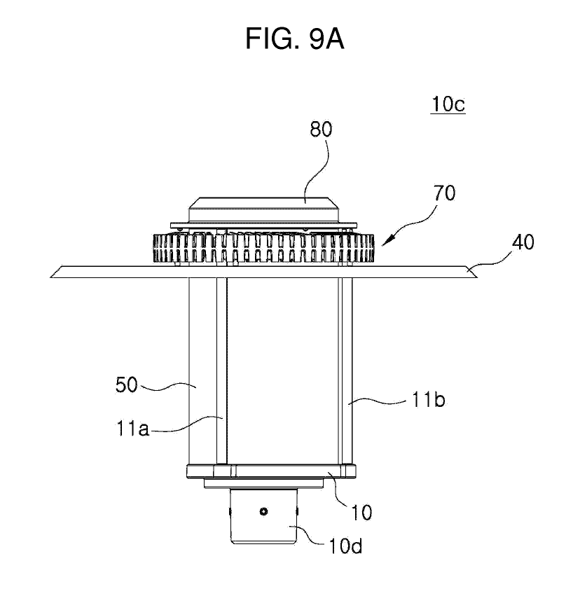

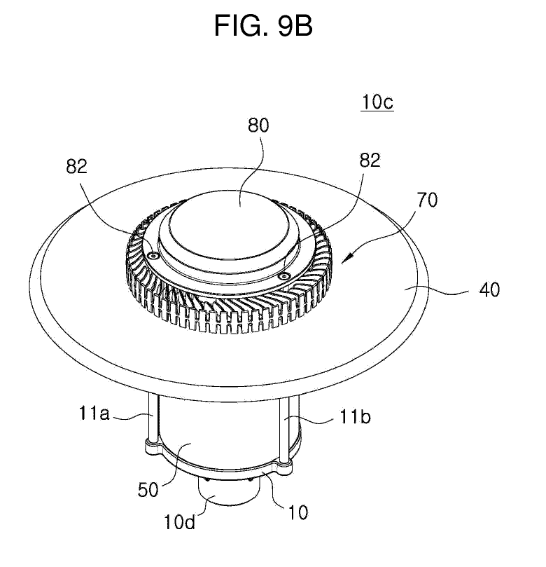

Referring to FIGS. 10A and 10B, a light-emitting diode (LED) streetlight according to a fifth embodiment of the present invention will be described below. The LED streetlight 100d in accordance with the fifth embodiment of the present invention is mostly identical to the LED streetlight 100 of the first embodiment of the present invention. Here, the former is different from the latter in a point that the former further includes a reflector 140 and a shape of a protective cover 150 of the former differs from that of the protective cover 50 of the latter.

The reflector 140 is integrally formed 80 along the top of the outer periphery of a top cover 80. In this case, auxiliary LEDs (not shown) that emit light of various colors are mounted on the upper surface of a base plate 71 of a heat sink 70. In the case that the top cover 80 is made of a synthetic resin such as acryl with opacity or a variety of colors, or is perforated to have a number of light passage holes (not shown), emotional illumination that light is emitted toward a road or sidewalk by the reflector 140, other than direct illumination. In this case, in order to facilitate installation of the auxiliary LEDs, it may be good to remove inner radiation fins 73c according to necessity.

As described above, in the case that the auxiliary LEDs (not shown) are employed, the top cover 80 may be also made of a high strength acrylic resin with transparency or a variety of colors instead of perforating a number of light passage holes.

The protective cover 150 is made in a bowl shape. An angle of appearance of the protective cover 150 may be arbitrarily set according to an angle at which the LED package 95 is mounted and depending on an angle of an LED lens. In other words, the protective cover 150 is formed to have rounded portions 151 having a predetermined angle at the bottom corner of the protective cover 150. As a result, the light emitted from the LED package 95 is set to be incident perpendicularly to the protective cover 150, to thus minimize the light reflected from the protective cover 150 and to increase a light transmission efficiency, and to thereby achieve a high-efficiency light distribution curve.

The protective cover 150 is made of a transparent synthetic resin, in particular, is preferably made of a high strength acrylic resin (PMMA) or polycarbonate (PC) having an excellent transmittance and strength.

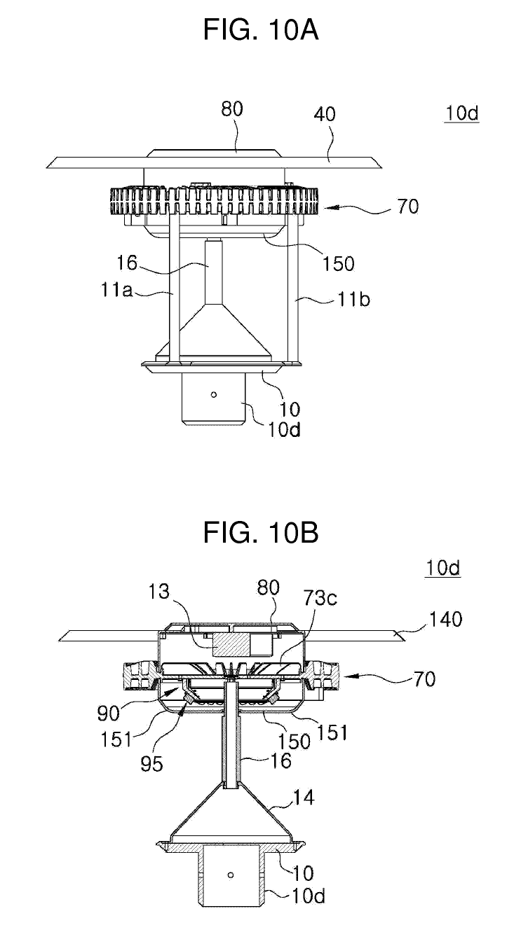

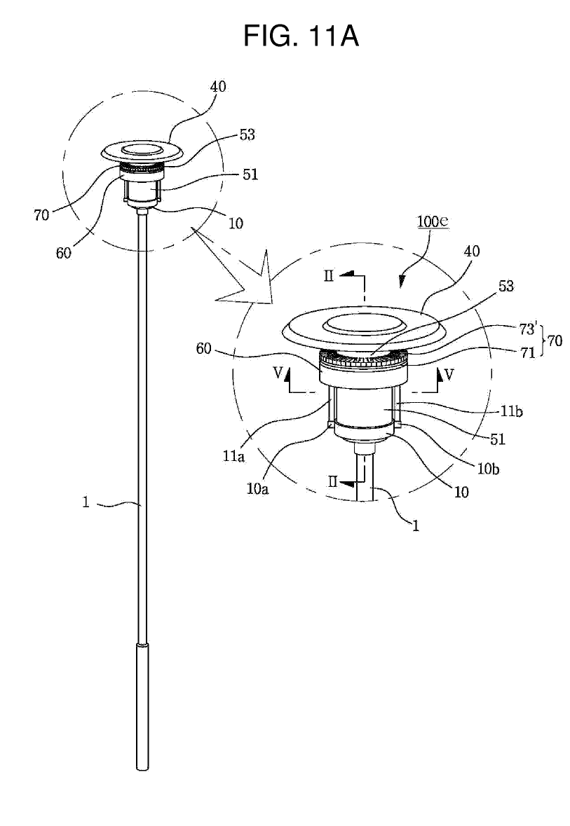

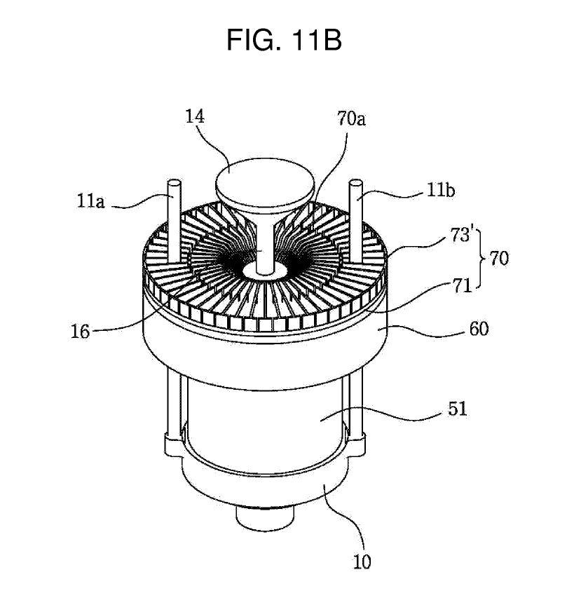

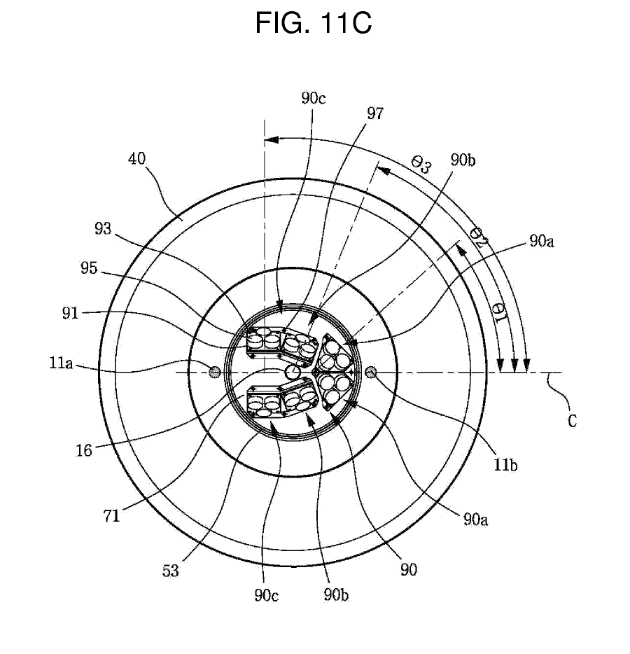

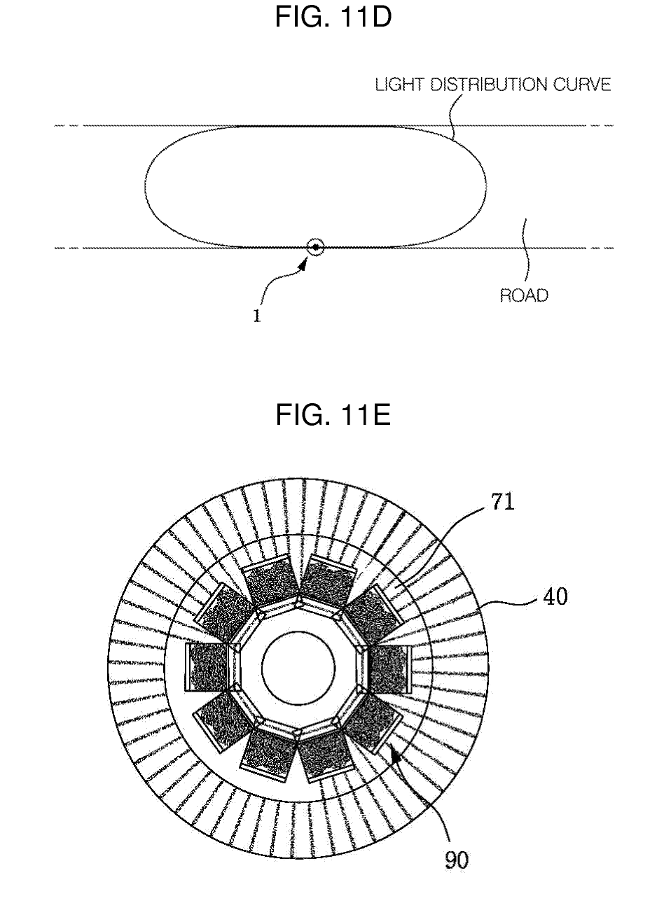

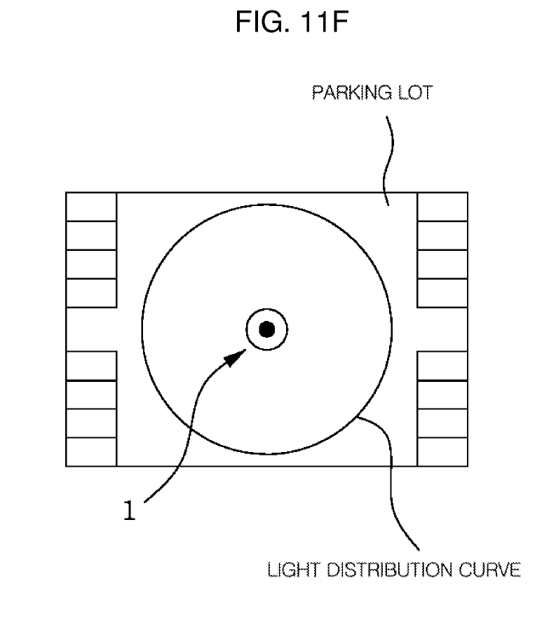

Referring to FIGS. 11A to 11FC, a light-emitting diode (LED) streetlight according to a sixth embodiment of the present invention will be described below. The LED streetlight 100e in accordance with the sixth embodiment of the present invention differs from the other embodiments of the present invention, in a point that a protective cover unit is configured to have two pieces of first and second protective covers 51 and 53 on the top and bottom of a heat sink 70, respectively.

The LED streetlight 100e according to the sixth embodiment includes the protective cover unit that is separated into the first and second protective covers 51 and 53. The first protective cover 51 is placed between a connection member 10 and the heat sink 70, and the second protective cover 53 is placed between the heat sink 70 and a reflector 40. Accordingly, the heat sink 70 is disposed across the first and second protective covers 51 and 53.

In this sixth embodiment, a glare-blocking member 60 includes a curved reflector having a predetermined curvature in the inside thereof. Accordingly, light blocked by the glare-blocking member 60 front among light emitted from the LED packages 95 of the LED module 90 is reflected to thus heighten an optical efficiency.

As shown in FIGS. 11B and 11C, the heat sink 70 includes a base plate 71 on the bottom surface of which a number of LED modules 90 are fixedly coupled with pieces, and a number of radiation fins 73′ that are radially arranged at predetermined intervals on the top surface of the base plate 71.

Annular grooves 70a into which the lower end of the second protective cover 53 is fixedly inserted are formed on the upper sides of the radiation fins 73′.

Referring back to FIG. 11C, the LED modules 90 include: a number of blocks 91 having inclined surfaces 93 that contact the base plate 71 of the heat sink 70 in which LEDs are mounted on the inclined surfaces 93; and a number of LED packages 95 that are coupled on the inclined surfaces 93 of the blocks 91 and that accommodate the LEDs, respectively. The inclined surfaces 93 are slopely formed at an angle corresponding to a tilt angle at a position where each block 91 is disposed.

In this case, as shown in FIG. 11D, in view of orientation of arrangement of the LED modules 90, the respective LED modules 90a, 90b, and 90c, are set around a central line C on a left-to-right symmetrical basis, in order to implement a light distribution curve of a type II-II appropriate for illuminating a bicycle road or motorway. Here, orient angles θ1, θ2, and θ3 of the respective LED modules 90a, 90b, and 90c are set as follows: θ1=30° to 50°; θ2=60° to 80°; and θ3=80° to 90°.

Meanwhile, in order to implement a light distribution curve of a type V-V appropriate for illuminating a wide place such as a park or parking lot, as shown in FIG. 11F, unlike the long and narrow places such as bike lanes and car road, it is desirable to arrange the LED modules 90 radially as shown in FIG. 11E.

As described above, according to the embodiments of the present invention, the LED modules 90 are disposed on the bottom surface of the base plate 71, in various forms. Also, the blocks 91 having, the inclined surfaces corresponding to a variety of tilt angles are applied in the embodiments of the present invention. As a result, a light distribution curve that is suitable for a desired illumination condition can be created.

In other words, a variety of light distribution curves may be implemented through a number of the LED modules 90 that are arranged in variety of arrays on the bottom surface of the heat sink 70. Also, since the heat sink 70 is disposed on the upper side of the glare-blocking member 60, heat generated from the LED modules 90 may be effectively discharged while maintaining a prototype of a post top light at maximum.

As described above, the post top LED streetlights 100, 100a, 100b, 100c, 100d, and 100e according to the first to sixth embodiments of the present invention may implement a variety of light distribution curves through a plurality of LED modules installed on the bottom surface of the heat sink 70 in a variety of arrays, and effectively discharges heat generated from the LED modules 90 through the heat sink 70, while maintaining a prototype of a post top light at maximum.

As described above, the present invention employs the glare-blocking member 60 such as a glare ring that utilizes a cutoff angle, to thus minimize a loss of light and a glare effect. Further, the present invention employs the curved reflector therein, to thus reflect light blocked by the glare-blocking member 60, and to thereby heighten an optical efficiency.

Moreover, the glare-blocking member 60 is formed to have a number of light passage holes in the present invention, or the glare-blocking member 60 is made of an acrylic material in opacity or with a variety of colors, to thereby implement emotional illumination other than direct illumination. The emotional illumination may be produced in various forms through a number of auxiliary LEDs, 97 that are placed on the upper side of the heat sink.

The present invention has been described with respect to a LED streetlight where a post top LED light is directly installed on the upper end of a post. However, the LED streetlight according to the present invention may be also applied to a case that a post or an arm extended from the post is connected to an upper reflector instead of the upper end of the post.

### INDUSTRIAL APPLICABILITY

As described above, the present invention may be widely applied to LED streetlights which require for high-efficiency heat radiation and a variety of light distribution curves, as well as general post top lights.

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

1. A light-emitting diode (LED) streetlight comprising:
a connection member that is placed on top of a post;
a transparent or translucent protective cover that is placed on top of the connection member;
at least one LED module that is surrounded by the protective cover; and
a heat sink that radiates heat generated from the LED module outwardly,
wherein the heat sink is placed on top of the protective cover, to thus form an accommodation space that accommodates the LED module together with the connection member, in which the LED module is placed on the bottom surface of the heat sink.

2. The light-emitting diode (LED) streetlight according to claim 1, further comprising a top cover that is detachably coupled on the upper side of the heat sink, to thus form an accommodation space between the heat sink and the top cover, and to thereby accommodate a power supply for the LED module.

3. The light-emitting diode (LED) streetlight according to claim 2, further comprising a reflector that is disposed between the heat sink and the top cover, and has a diameter larger than that of the heat sink.

4. The light-emitting diode (LED) streetlight according to claim 1, further comprising a reflector that is disposed between the protective cover and the heat sink, and has a diameter larger than that of the heat sink.

5. The light-emitting diode (LED) streetlight according to claim 1, further comprising a glare-blocking member that surrounds the outer circumference of the upper side of the protective cover.

6. The light-emitting diode (LED) streetlight according to claim 5, wherein the glare-blocking member is position-set at a height that corresponds to a location where the LED module is installed.

7. The light-emitting diode (LED) streetlight according to claim 1, wherein the LED module comprises: a plurality of blocks that are fixed on the bottom surface of the heat sink, and wherein each block comprises: at least one LED package; and at least one inclined surface on which the LED package is placed.

8. The light-emitting diode (LED) streetlight according to claim 7, wherein each inclined surface of each block has a pre-set tilt angle so as to implement a desired light distribution curve through the LED module, and is fixed on the bottom surface of the heat sink in a direction corresponding to the light distribution curve.

9. The light-emitting diode (LED) streetlight according to claim 5, wherein the lower end of the glare-blocking member is set in correspondence to a location where both a tilt angle and a cutoff angle of the LED module with respect to the LED package match.

10. The light-emitting diode (LED) streetlight according to claim 1, wherein the heat sink comprises:
a flat base plate on the bottom surface of which the at least one LED module is installed; and
a plurality of radiation fins protruding radially on the top and bottom surfaces of the base plate.

11. The light-emitting diode (LED) streetlight according to claim 1, wherein the radiation fins comprises outer radiation fins that are arranged out on the top and bottom surfaces of the base plate.

12. The light-emitting diode (LED) streetlight according to claim 10, wherein the radiation fins further comprises inner radiation fins that are arranged inwardly on the top surface of the inner portion of the base plate.

13. The light-emitting diode (LED) streetlight according to claim 10, further comprising at least one auxiliary LED that is installed on the top surface of the base plate, wherein a number of light passage holes are formed on the top cover, to thus implement emotional illumination through the auxiliary LED.

14. The light-emitting diode (LED) streetlight according to claim 1, wherein the LED module is arranged around the center of the heat sink on a left-to-right symmetrical basis.

15. The light-emitting diode (LED) streetlight according to claim 1, wherein the protective cover is formed in a bowl shape so that light emitted from the LED package is perpendicularly incident, by arbitrarily setting an angle of the appearance of the protective cover.

16. The light-emitting diode (LED) streetlight according to claim 1, further comprising a number of support rods both ends of which are connected between the connection member and the heat sink to thus fix the protective cover outwardly from the protective cover.

17. The light-emitting diode (LED) streetlight according to claim 1, wherein the LED module is arranged radially.

18. The light-emitting diode (LED) streetlight according to claim 1, wherein the protective cover comprises first and second protective covers that are respectively disposed at the upper and lower sides of the heat sink.

19. The light-emitting diode (LED) streetlight according to claim 13, further comprising:
a conduit that is provided at the center of a vessel-shaped cover through the heat sink, and through which a power cable for supplying electric power to the LED module;
a first reflector that is coupled to the lower end of the conduit and reflects light emitted from the LED of the LED module; and
a second reflector that is coupled to the upper end of the conduit and reflects light emitted from the auxiliary LED.
